(19) United States
(12) Patent Application Publication
(10) Pub. No.: US 2019/0351576 A1
(43) Pub. Date: Nov. 21, 2019

(54) CERAMIC COMPONENT AND THREE-DIMENSIONAL MANUFACTURING METHOD OF CERAMIC COMPONENT

(71) Applicant: Seiko Epson Corporation, Tokyo (JP)

(72) Inventors: Masaya ISHIDA, Hara-mura (JP); Toshimitsu HIRAI, Hokuto (JP); Eiji OKAMOTO, Matsumoto (JP)

(73) Assignee: Seiko Epson Corporation, Tokyo (JP)

(21) Appl. No.: 15/999,106

(22) PCT Filed: Jan. 31, 2017
(86) PCT No.: PCT/JP2017/003484

§ 371 Date: Aug. 17, 2018

(30) Foreign Application Priority Data
Feb. 18, 2016 (JP) 2016-029003

(51) Int. Cl. B28B 1/30; C04B 37/02; C04B 35/04; C04B 35/14

(52) U.S. Cl. CPC B28B 1/30; C04B 35/14; C04B 35/04; C04B 37/02

(57) ABSTRACT

A ceramic component is provided that is suitable to be placed in high temperature environment. The component includes a first member that is formed of a first material, and a ceramic layer that is bonded to a surface of the first member, which is a side exposed to the high temperature environment and that is formed of a ceramic material having a higher heat resistance than that of the first member. A bonding portion between the first member and the ceramic layer is formed of a composite material having the first material and the ceramic material, and a gradient composition in which an abundance ratio of the first material gradually decreases and an abundance ratio of the ceramic material gradually increases in a direction from the first member to the ceramic layer.

### CROSS-REFERENCE TO RELATED APPLICATIONS

This application is a U.S. National Stage Application of International Application No. PCT/JP2017/003484, filed Jan. 31, 2017, and published in Japanese as WO 2017/141697 A1 on Aug. 24, 2017, which claims priority to Japanese Patent Application No. 2016-029003, filed on Feb. 18, 2016. The entire disclosures of the above applications are incorporated herein by reference.

### BACKGROUND

### Technical Field

The present invention relates to a ceramic component in which a ceramic coating (layer) having higher heat resistance than that of a first member formed of a material such as metal is provided on a front surface side of the first member, and a three-dimensional manufacturing method of the ceramic component.

### Background Art

Japanese Unexamined Patent Application Publication No. 9-194909 describes a composite material which is a composite material provided by sintering and bonding a sintered body (ceramic) with a lamination structure having a different composition is formed on a surface of a metal substrate of which shape is determined in advance, and in which a volume relationship between the sintered body and the substrate is specified and the thickness of each layer is specified. It is described that performance of an uppermost layer requiring abrasion resistance and corrosion resistance can be significantly improved while promoting stress relaxation in each layer by specifying the thickness of each layer of the volume relation (0012).

Furthermore, as a method of bonding the sintered body, it is described that a raw material member of the sintered body is placed on the surface of the metal substrate, heated by a heating mechanism, and pressure is applied by a pressurizing mechanism to sinter the raw material powder and bond the raw material powder to the substrate (0034).

In the composite material described in Japanese Unexamined Patent Application Publication No. 9-194909, the sintered body is heated to the surface of the metal substrate of which shape is determined in advance by the heating mechanism and pressure is applied by the pressurizing mechanism to sinter the raw material powder and bond the raw material powder to the substrate as described above. Therefore, there is a possibility that a bonding interface between the surface of the original substrate and the sintered body bonded later is present even after sintering and bonding, and when exposed to a high temperature environment, the sintered body may be separated at the bonding interface.

An object of the present invention is to suppress the problem of separating of a ceramic layer while improving heat resistance in a ceramic component placed in a high temperature environment.

### SUMMARY

In order to solve the above problems, according to a first aspect of the present invention, there is a provided a ceramic component placed in high temperature environment, the component including a first member that is formed of a first material, and a ceramic layer that is bonded to a surface of the first member, which is a side exposed to the high temperature environment and that is formed of a ceramic material having a higher heat resistance than that of the first member, in which a bonding portion between the first member and the ceramic layer is formed of a composite material having the first material and the ceramic material, and a gradient composition in which an abundance ratio of the first material gradually decreases and an abundance ratio of the ceramic material gradually increases in a direction from the first member to the ceramic layer.

Here, the description that “formed of the first material” in the “first member formed of the first material” means to include both of the first member formed of only the first material and the first member is formed of the first material as a main material and other materials.

In addition, the description that “formed of the ceramic material” in the “ceramic layer formed of the ceramic material” means to include both of the ceramic layer formed of only the ceramic material and the ceramic layer is formed of the ceramic material as a main material and other materials.

According to this aspect, the bonding portion between the first member and the ceramic layer in the ceramic component placed in the high temperature environment is formed of the composite material having the first material and the ceramic material, and the gradient composition in which the abundance ratio of the first material gradually decreases and the abundance ratio of the ceramic material gradually increases in a direction from the first member to the ceramic layer. Due to the gradient composition of the bonding portion, it is possible to suppress the problem of separating of the ceramic layer while improving the heat resistance in the ceramic component placed in the high temperature environment.

The gradient composition of the bonding portion of the first member and the ceramic layer can be easily achieved by a three-dimensional manufacturing method of a ceramic component described later.

According to a second aspect of the present invention, in the ceramic component in the first aspect, the ceramic layer is formed of a plurality of layers, the plurality of layers are formed of different ceramic materials, and the bonding portions of the respective layers of the plurality of layers are configured to have the gradient composition.

According to this aspect, the bonding portion between each of the layers of the plurality of layers constituting the ceramic layer is configured to have the gradient composition. That is, the adjacent layers of the plurality of layers formed of different ceramic materials are configured to have the gradient composition. Therefore, it is possible to increase the bonding strength between different ceramic materials, so that the possibility of separation in the ceramic layer configured to have a plurality of layers can be reduced.

According to a third aspect of the present invention, in the ceramic component in the first aspect, the ceramic layer is formed of a plurality of layers, the plurality of layers have different properties, and the bonding portions of the respective layers of the plurality of layers are configured to have the gradient composition.

Herein, the description that “properties of the plurality of layers are different” includes properties of high environmental resistance such as acid resistance (corrosive property) and water resistance, low thermal conductivity, and the like, in addition to the property of the high heat resistance required for the ceramic component placed in the high temperature environment.

According to this aspect, the adjacent ceramic layers having different properties such as high heat resistance and high environmental resistance are bonded to each other with the gradient composition. Therefore, it is possible to increase the bonding strength between the adjacent layers of the plurality of layers having different properties, so that the possibility of separation in the ceramic layer configured to have a plurality of layers can be reduced.

According to a fourth aspect of the present invention, in the ceramic component in any one aspect of the first aspect to the third aspect, an entire surface of the first member is covered with the ceramic layer.

According to this aspect, since the entire surface of the first member is covered with the ceramic layer, the problem of separation of the ceramic layer can be suppressed while further improving the heat resistance as compared with the member provided with the ceramic layer only at the portion exposed to the high temperature environment.

According to a fifth aspect of the present invention, in the ceramic component in any one aspect of the first aspect to the fourth aspect, a layer thickness of the ceramic layer is 200 μm or more.

According to this aspect, since the ceramic layer has the layer thickness of 200 μm or more, the effect of the high heat resistance can be stably and evenly achieved.

According to a sixth aspect of the present invention, in the ceramic component in any one aspect of the first aspect to the fifth aspect, a thickness of the gradient composition portion is 200 μm or more.

According to this aspect, since the thickness of the gradient composition portion is 200 μm or more, a reduction in the possibility of separation of the ceramic layer can be stably and evenly achieved.

According to a seventh aspect of the present invention, in the ceramic component in any one aspect of the first aspect to the sixth aspect, the first material is one or more materials selected from an SUS alloy, a titanium alloy, a nickel base alloy, and a cobalt base alloy, and the ceramic material is one or more materials selected from alumina, zirconia, silicon nitride, aluminum nitride, silicon carbide, cordierite, mullite, steatite, calcia, magnesia, sialon, yttria stabilized zirconia, Dy₂O₃—ZrO₂, Y₂O₃—HfO₂, ZrB₂, and HfB₂.

According to this aspect, by using these materials as the first material and the ceramic material, it is possible to effectively obtain the effects of the respective aspects.

A three-dimensional manufacturing method of a ceramic component of an eighth aspect of the present invention, placed in a high temperature environment and which includes a first member formed of a first material, and a ceramic layer bonded to a surface of the first member, which is a side exposed to the high temperature environment and formed of a ceramic material having a higher heat resistance than that of the first member, the method including a layer formation step of forming one layer by ejecting a first fluid composition containing particles of the first material from a first ejection portion to a portion corresponding to the first member, ejecting a second fluid composition containing particles of the ceramic material from a second ejection portion to a portion corresponding to the ceramic layer, and ejecting each of the fluid compositions so as to form a gradient composition in which an abundance ratio of the particles of the first material gradually decreases and an abundance ratio of the particles of the ceramic material gradually increases in a direction from the first member to the ceramic layer at a portion corresponding to a bonding portion between the first member and the ceramic layer, and a solidification step of applying energy to each particle in the layer to solidify the particles, and in which the ceramic component is formed by repeating the layer formation step and the solidification step in a lamination direction.

According to this aspect, in the layer formation step, each composition is ejected so as to form the gradient composition in which the abundance ratio of the particles of the first material gradually decreases and the abundance ratio of the particles of the ceramic material gradually increases in the direction from the first member to the ceramic layer at the portion corresponding to the bonding portion between the first member and the ceramic layer. As a result, the ceramic component according to the first aspect to the seventh aspect can be easily manufactured.

According to a ninth aspect of the present invention, in the three-dimensional manufacturing method of the ceramic component in the eighth aspect, in the layer formation step, the ceramic layer is formed on a plurality of layers with different ceramic materials, and a fluid composition of the each of the ceramic materials is ejected from each ejection portion so as to form the gradient composition between the respective layers of the plurality of layers.

According to this aspect, the ceramic component of the second aspect can be easily manufactured.

According to a tenth aspect of the present invention, in the three-dimensional manufacturing method of the ceramic component in the eighth aspect, in the layer formation step, the ceramic layer is formed on a plurality of layers with different properties, and a fluid composition of the ceramic material corresponding to each property is ejected from each ejection portion so as to form the gradient composition between the respective layers of the plurality of layers.

According to this aspect, the ceramic component of the third aspect can be easily manufactured.

### BRIEF DESCRIPTION OF DRAWINGS

FIG. 1 is a side cross-sectional view illustrating a ceramic component according to Embodiment 1 of the present invention.

FIG. 2 is a side cross-sectional view schematically illustrating an example of a gradient composition of the ceramic component according to Embodiment 1 of the present invention.

FIG. 3 is a side cross-sectional view illustrating a ceramic component according to Embodiment 2 of the present invention.

FIG. 4 is a side cross-sectional view illustrating a ceramic component according to Embodiment 3 of the present invention.

FIG. 5 is a side cross-sectional view illustrating a ceramic component according to Embodiment 4 of the present invention.

FIG. 6 is an explanatory diagram illustrating a layer formation step of a three-dimensional manufacturing method of a ceramic component according to Embodiment 5 of the present invention.

FIG. 7 is an explanatory diagram illustrating a solidification step of the three-dimensional manufacturing method of the ceramic component according to Embodiment 5 of the present invention.

FIG. 8 is a side cross-sectional view illustrating the ceramic component and a support material formed by the three-dimensional manufacturing method of the ceramic component according to Embodiment 5 of the present invention.

### DETAILED DESCRIPTION

Hereinafter, a ceramic component and a three-dimensional manufacturing method of the ceramic component according to the embodiment of the present invention will be described in detail with reference to the attached drawings.

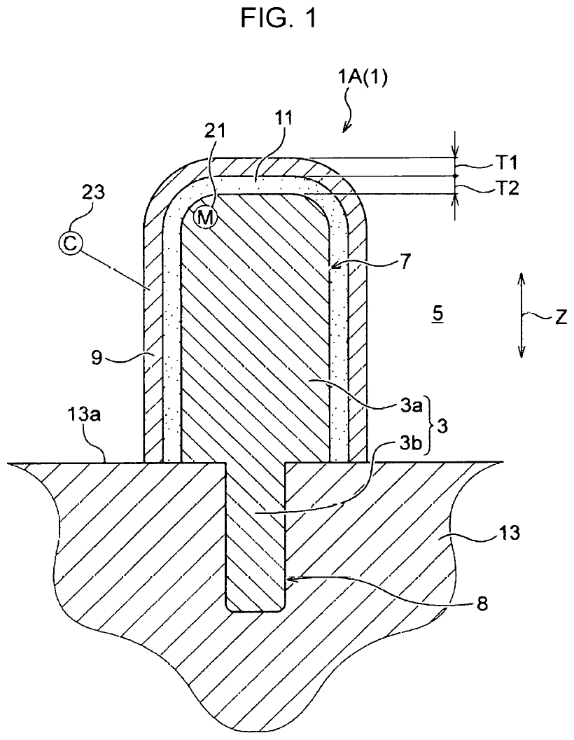

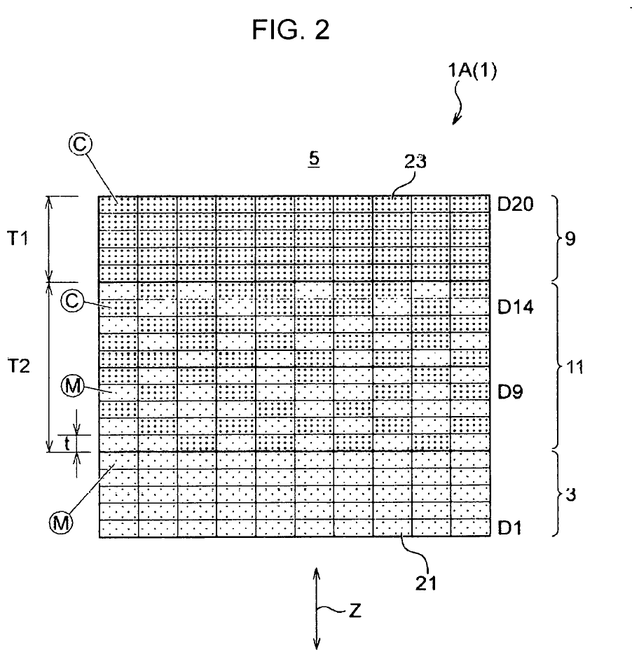

In the following description, first, a configuration of the ceramic component according to Embodiment 1 of the present invention and an operation thereof will be specifically described with reference to Embodiment 1 illustrated in FIGS. 1 and 2 as an example.

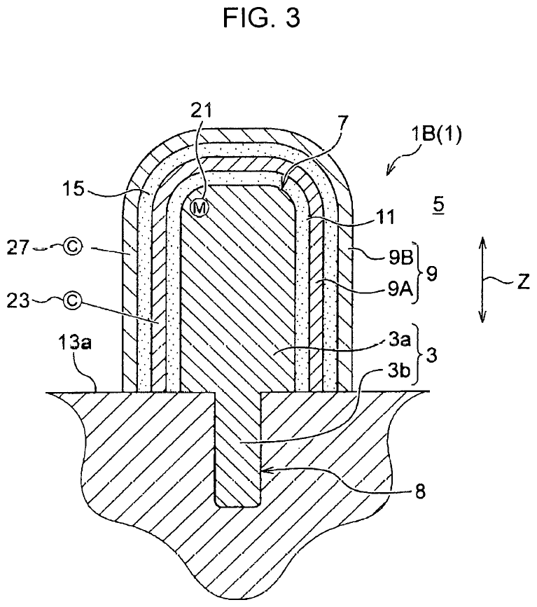

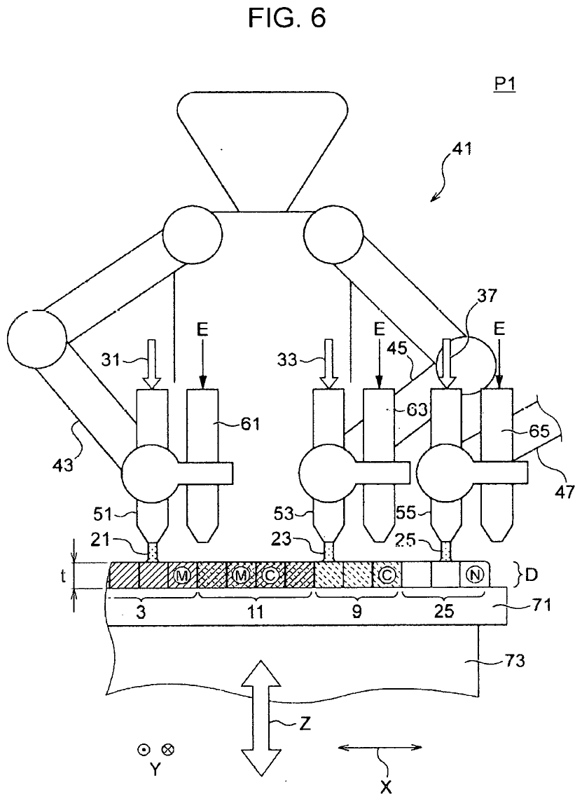

Next, for the three embodiments according to Embodiment 2 to Embodiment 4 individually illustrated in FIGS. 3 to 5, the configuration of the ceramic component and the operation thereof will be described focusing on a difference from Embodiment 1. Next, the contents of the three-dimensional manufacturing method of the ceramic component according to Embodiment 5 of the present invention will be described with reference to FIGS. 6 to 8 with a schematic configuration of a three-dimensional manufacturing apparatus used in the three-dimensional manufacturing method. Finally, another embodiment of the ceramic component of the present invention which is different in partial configuration from each of the above embodiments and the three-dimensional manufacturing method of the ceramic component will be described.

### Embodiment 1 (Refer to FIGS. 1 and 2)

The ceramic component 1A according to Embodiment 1 is a ceramic component placed in high temperature environment 5, and is provided with a first member 3 formed of a first material 21, and a ceramic layer 9 bonded to a surface 7 of the first member 3, which is a side exposed to the high temperature environment 5 and formed of a ceramic material 23 which is a second material having higher heat resistance than that of the first member 3.

A composite layer 11 formed of a composite material having the first material 21 and the ceramic material 23 is provided at a bonding portion between the first member 3 and the ceramic layer 9. The composite layer 11 is configured to have a gradient composition in which an abundance ratio of the first material 21 gradually decreases and an abundance ratio of the ceramic material 23 gradually increases in a direction from the first member 3 to the ceramic layer 9.

Here, the description that “formed of the first material 21” in the “first member 3 formed of the first material 21” means to include both of the first member 3 formed of only the first material 21 and the first member 3 is formed of the first material 21 as a main material and other materials.

In addition, the description that “formed of the ceramic material 23” in the “ceramic layer 9 formed of the ceramic material 23” means to include both of the ceramic layer 9 formed of only the ceramic material 23 and the ceramic layer 9 is formed of the ceramic material 23 as a main material and other materials.

In addition, the description that “surface 7 which is a side exposed to the high temperature environment 5” means an exposed surface directly placed in the high temperature environment 5 excluding a mounting surface 8 with a mounting target portion 13 and directly affected by the high temperature environment 5 in a state where the ceramic component 1 is mounted to the mounting target portion 13 at a predetermined use place as illustrated in the drawing.

In Embodiment 1, a metal material is used as the first material 21 as an example, and specifically, one or more materials selected from an SUS alloy, a titanium alloy, a nickel base alloy, and a cobalt base alloy can be applied.

In addition, as the ceramic material 23, a thermal barrier coating material can be applied, and specifically, one or more materials selected from alumina, zirconia, silicon nitride, aluminum nitride, silicon carbide, cordierite, mullite, steatite, calcia, magnesia, sialon, yttria stabilized zirconia, Dy₂O₃—ZrO₂, Y₂O₃—HfO₂, ZrB₂, and HfB₂ can be applied.

In addition, as illustrated in FIG. 1, in Embodiment 1, the first member 3 is configured as an example with a short rod member having a large diameter portion 3a and a small diameter portion 3b, and an upper surface and a side peripheral surface of the large diameter portion 3a, except for an outer peripheral surface of the small diameter portion 3b embedded in the mounting target portion 13 and a lower surface of the large diameter portion 3a in contact with the upper surface 13a of the mounting target portion 13, are the surface 7 which are the side exposed to the high temperature environment 5.

In addition, the ceramic layer 9 is provided so as to cover the upper surface and the side peripheral surface of the large diameter portion 3a of the first member 3, and the composite layer 11 is provided between the ceramic layer 9 and the upper surface and the side peripheral surface of the large diameter portion 3a of the first member 3.

In addition, the layer thickness T1 of the ceramic layer 9 is preferably 200 μm or more, and the thickness T2 of the composite layer 11 to which the gradient composition is applied is preferably 200 μm or more.

In addition, as illustrated in FIG. 2, the composite layer 11 is preferably formed by laminating each layer D (D9, D14) on four or more layers as an example, and in this case, the thickness t is preferably set to 50 μm or more per layer.

In a case where the thickness T2 of the composite layer 11 and the thickness t of the layer D are specified in this manner, it is possible to improve the heat resistance of the ceramic layer 9 and to reduce the propagation of heat to the laminated lower layer D.

In addition, FIG. 2 schematically illustrates an example of the gradient composition applied to the composite layer 11. In the illustrated Embodiment 1, a laminated model of the ceramic component 1A provided with the lower first member 3 having five layers D1, the upper ceramic layer 9 similarly having five layers 20, and the composite layer 11 having 10 layers having the five layers D9 and the five layers D14 in total between these layers is disclosed as an example.

In the laminated model of the ceramic component 1A, a gradient composition in which the abundance ratio of the first material 21 in the composite layer 11 gradually decreases in the direction from the first member 3 to the ceramic layer 9, and the abundance ratio of the ceramic material 23 in the composite layer 11 gradually increases in the direction from the first member 3 to the ceramic layer 9 is applied.

As an example, in the layer D9 forming the composite layer 11 in FIG. 2, the abundance ratio of the first material 21 is 60% and the abundance ratio of the ceramic material 23 is 40%, and in the layer D14 forming the composite layer 11 in FIG. 2, the abundance ratio of the first material 21 is 40% and the abundance ratio of the ceramic material 23 is 60%.

According to the ceramic component 1A according to Embodiment 1 configured as described above, in the ceramic component placed in the high temperature environment 5, it is possible to suppress the problem of separating of the ceramic layer 9 from the first member 3 while improving the heat resistance.

### Embodiment 2 (Refer to FIG. 3)

In the ceramic component 1B according to Embodiment 2, the configuration of the ceramic layer 9 is partially different from that of the ceramic component 1A according to Embodiment 1, and the basic configuration of the ceramic layer 9 and the configurations of the first member 3 and the composite layer 11 are the same as those of Embodiment 1.

Therefore, the description of the same configuration as in Embodiment 1 will be omitted here, and the configuration and operation unique to Embodiment 2 which is different from those of Embodiment 1 will be described.

That is, in Embodiment 2, the ceramic layer 9 is configured to include a plurality of layers 9A and 9B, and the plurality of layers 9A and 9B are formed of different ceramic materials 23 and 27. A separate composite layer 15 having the gradient composition similar to that of the composite layer 11, is provided at the bonding portion between each layer of the plurality of layers 9A and 9B.

Specifically, in the illustrated Embodiment 2, the ceramic layer 9 is configured to include two ceramic layers of the first ceramic layer 9A provided on the inner side covering the first member 3 and the second ceramic layer 9B provided on the outer side covering the first ceramic layer 9A. A separate composite layer 15 formed of the gradient composition between the ceramic material 23 as the second material and a separate ceramic material 27 as a third material is provided between the first ceramic layer 9A and the second ceramic layer 9B.

Even with the ceramic component 1B according to Embodiment 2 configured in this manner, the same operation and effect as that of Embodiment 1 is achieved, so that it is possible to improve the heat resistance of the ceramic component 1B, and to suppress the problem of separating of the ceramic layer 9 from the first member 3.

In addition, in Embodiment 2, due to the presence of the separate composite layer 15 formed of the gradient composition, the bonding strength between the different ceramic materials 23 and 27 can be increased. Therefore, it possible to reduce the possibility of separation in the ceramic layer 9 configured to include the plurality of layers 9A and 9B.

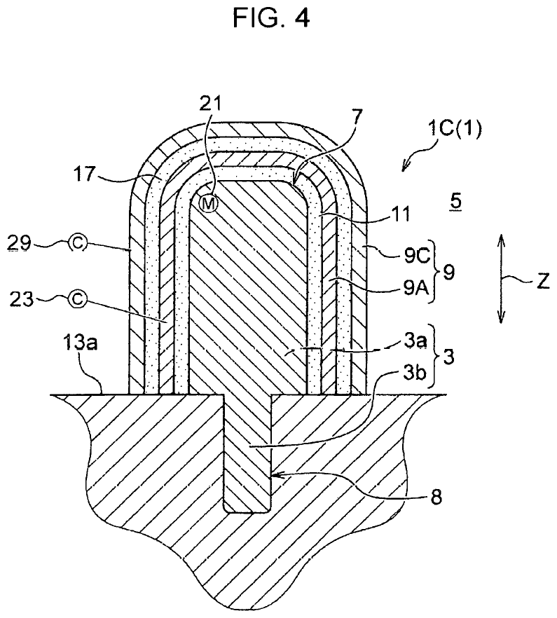

### Embodiment 3 (Refer to FIG. 4)

In the ceramic component 1C according to Embodiment 3, the configuration of the ceramic layer 9 is partially different from that of the ceramic component 1A according to Embodiment 1, and the basic configuration of the ceramic layer 9 and the configurations of the first member 3 and the composite layer 11 are the same as those of Embodiment 1.

Therefore, the description of the same configuration as in Embodiment 1 will be omitted here, and the configuration and operation unique to Embodiment 3 which is different from those of Embodiment 1 will be described.

That is, in Embodiment 3, similar to Embodiment 2, the ceramic layer 9 is configured to include a plurality of layers 9A and 9C, and the plurality of layers 9A and 9C are formed of ceramic materials 23 and 29 of the same type or different types with different properties. In addition, a separate composite layer 17 having the gradient composition similar to that of the composite layer 11, is provided at the bonding portion between each layer of the plurality of layers 9A and 9C.

The description that “properties of the plurality of layers 9A and 9C are different” as referred to herein includes properties of high environmental resistance such as acid resistance (corrosive property) and water resistance as chemical stability, low thermal conductivity, insulation property, and the like, in addition to the property of the high heat resistance required for the ceramic component 1C placed in the high temperature environment 5.

Specifically, in the illustrated Embodiment 3, the ceramic layer 9 is configured to include two ceramic layers of the first ceramic layer 9A provided on the inner side covering the first member 3 and the third ceramic layer 9C provided on the outer side covering the first ceramic layer 9A. A separate composite layer 17 formed of the gradient composition between the ceramic material 23 as the second material and a separate ceramic material 29 with different properties as a fourth material is provided between the first ceramic layer 9A and the third ceramic layer 9C.

Even with the ceramic component 1C according to Embodiment 3 configured in this manner, the same operation and effect as that of Embodiment 1 is achieved, so that it is possible to improve the heat resistance of the ceramic component 1C, and to suppress the problem of separating of the ceramic layer 9 from the first member 3.

In addition, in Embodiment 3, due to the presence of the separate composite layer 17 formed of the gradient composition, the bonding strength between adjacent each layer of the plurality of layers 9A and 9C with different properties can be increased. Therefore, it possible to reduce the possibility of separation in the ceramic layer 9 configured to include the plurality of layers 9A and 9C.

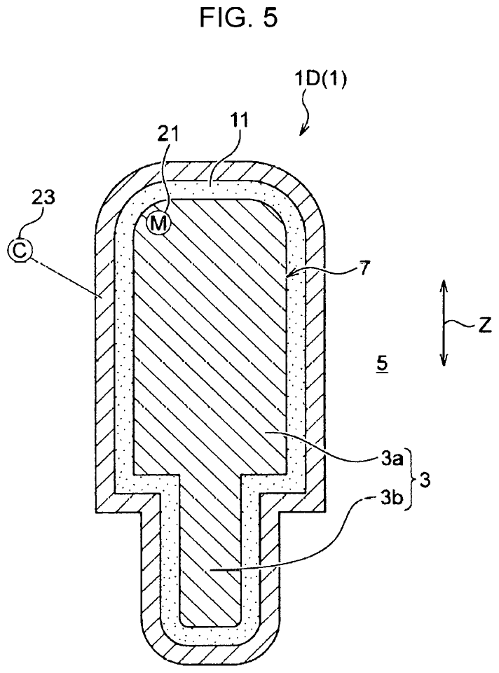

### Embodiment 4 (Refer to FIG. 5)

In the ceramic component 1D according to Embodiment 4, an installation range of the ceramic layer 9 and the composite layer 11 is different from that of the ceramic component 1A according to Embodiment 1, and the basic configuration of the ceramic layer 9 and the configurations of the first member 3 and the composite layer 11 are the same as those of Embodiment 1.

Therefore, the description of the same configuration as in Embodiment 1 will be omitted here, and the configuration and operation unique to Embodiment 4 which is different from those of Embodiment 1 will be described.

That is, in Embodiment 4, the entire surface of the first member 3 in the ceramic component 1D is covered with the ceramic layer 9.

Specifically, the ceramic component 1D is not mounted to the mounting target portion 13, and the entire surface of the first member 3 is the surface 7 to be the side exposed to the high temperature environment 5. As a result, the ceramic layer 9 is provided so as to cover the entire surface of the first member 3, and the composite layer 11 is provided so as to cover the entire surface of the first member 3 which is the bonding portion between the ceramic layer 9 and the first member 3.

Even with the ceramic component 1D according to Embodiment 4 configured in this manner, the same operation and effect as that of Embodiment 1 is achieved, so that it is possible to improve the heat resistance of the ceramic component 1D, and to suppress the problem of separating of the ceramic layer 9 from the first member 3.

In addition, in Embodiment 4, it is possible to further improve the heat resistance as compared with the ceramic component 1A according to Embodiment 1, so that the problem of separating of the ceramic layer 9 can be further suppressed.

### Embodiment 5 (Refer to FIGS. 6 to 8)

Next, according to Embodiment 5, a schematic configuration of a three-dimensional manufacturing apparatus 41 usable for manufacturing the ceramic component 1A according to Embodiment 1 and the contents of an example of the three-dimensional manufacturing method of the ceramic component of the present invention performed by using the three-dimensional manufacturing apparatus 41 will be described.

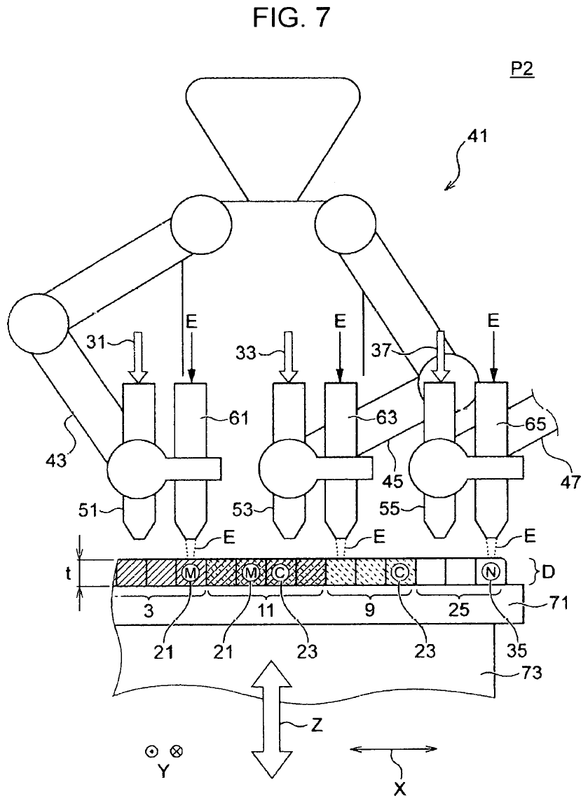

(1) Schematic Configuration of Three-Dimensional Manufacturing Apparatus (Refer to FIGS. 6 and 7)

As the three-dimensional manufacturing apparatus 41 for manufacturing the ceramic component 1A, an articulated industrial robot having a plurality of robot arms 43, 45, and 47 as an example can be adopted.

Specifically, a first ejection head 51 for ejecting a first fluid composition 31 containing metal particles M of the first material 21 which is a material for the first member 3, a second ejection head 53 for ejecting a second fluid composition 33 containing ceramic particles C of the second material 23 which is a material for the ceramic layer 9, and a third ejection head 55 for ejecting a third fluid composition 37 containing particles N of a fifth material 35 which is a material for a support material 25 are provided. These three types of ejection heads 51, 53, and 55 are a first ejection portion 51, a second ejection portion 53, and a third ejection portion 55, respectively.

In addition, the three-dimensional manufacturing apparatus 41 is provided with a plurality of irradiation heads 61, 63, and 65 for individually irradiating and solidifying the metal particles M of the first material 21, the ceramic particles C of the second material 23, and the particles N of the fifth material 35, which are contained in each of the fluid compositions 31, 33, and 37 ejected from the ejection heads 51, 53, and 55 with laser beam E as an example of energy, a stage 73 provided with a flat plate-like base plate 71 as an example in which each of the fluid compositions 31, 33, and 37 is ejected and which forms a layer formation region on the upper surface thereof, a driving portion (not illustrated) for driving the robot arms 43, 45, and 47 and moving up and down the stage 73 in a lamination direction Z, and a control portion (not illustrated) for driving these driving portions, ejection control of each of the fluid compositions 31, 33, and 37 ejected from the ejection heads 51, 53, and 55, and irradiation control of the laser beam E irradiated from the irradiation heads 61, 63, and 65. The three-dimensional manufacturing apparatus 41 is used for manufacturing the ceramic component 1A placed in the high temperature environment 5 by including these members as an example.

(2) Contents of Three-Dimensional Manufacturing Method of Ceramic Component (Refer to FIGS. 6 to 8)

The three-dimensional manufacturing method of the ceramic component according to Embodiment 5 is a three-dimensional manufacturing method of the ceramic component 1A placed in the high temperature environment 5 and which includes the first member 3 formed of the first material 21, and the ceramic layer 9 bonded to the surface 7 of the first member 3 to be the side exposed to the high temperature environment 5 and formed of the ceramic material 23 having higher heat resistance than that of the first member 3, includes a layer formation step P1 and a solidification step P2, and is basically configured by repeating the layer formation step P1 and the solidification step P2 in the lamination direction Z to form the ceramic component 1A.

Hereinafter, the contents of the layer formation step P1 and the solidification step P2 and the process of repeating these steps P1 and P2 in the lamination direction Z to form the ceramic component 1A will be described in detail.

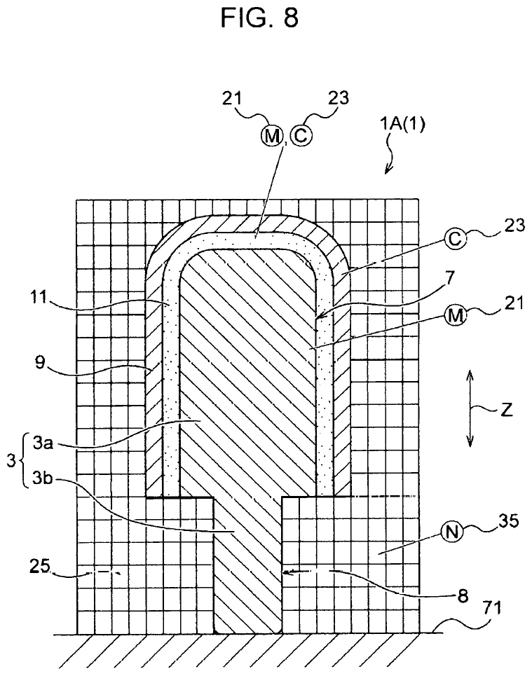

(A) Layer Formation Step (Refer to FIGS. 6 and 8)

The layer formation step P1 is a step of forming one layer D by ejecting the first fluid composition 31 containing the metal particles M of the first material 21 from the first ejection portion 51 to a portion corresponding to the first member 3, ejecting the second fluid composition 33 containing the ceramic particles C of the ceramic material 23 from the second ejection portion 53 to a portion corresponding to the ceramic layer 9, and ejecting each of the fluid compositions 31 and 33 so as to form a gradient composition in which the abundance ratio of the metal particles M of the first material 21 gradually decreases and the abundance ratio of the ceramic particles C of the ceramic material 23 gradually increases in the direction from the first member 3 to the ceramic layer 9 at the portion corresponding to the composite layer 11 provided at the bonding portion between the first member 3 and the ceramic layer 9.

Furthermore, in Embodiment 5, as illustrated in FIG. 8, the third fluid composition 37 containing the particles N of the fifth material 35 which is a material for the support material 25 is supplied from the third ejection portion 55 to a predetermined portion to form one layer D.

In addition, in Embodiment 5, all of the three types of ejection portions are configured to include the ejection heads 51, 53, and 55, respectively, so that all of the three types of fluid compositions 31, 33, and 37 are configured to be ejected in a droplet state.

In addition, the three types of ejection portions 51, 53, and 55 may not necessarily be configured to include the ejection heads, and it is possible to configure a portion or all of these to include other means having different structures (for example, coating rollers).

As the particles of the first material 21 which is the material of the first member 3, the ceramic particles C may be used, in addition to the metal particles M described in Embodiment 1. The metal particles M are not limited to those described in Embodiment 1, and various metal or metal compound particles described below can be applied depending on usage conditions, applications, and the like.

Examples thereof include various metals such as aluminum, titanium, iron, copper, magnesium, stainless steel, and maraging steel, various metal oxides such as silica, alumina, titanium oxide, zinc oxide, zirconium oxide, tin oxide, magnesium oxide, and potassium titanate, various metal nitrides such as silicon nitride, titanium nitride, and aluminum nitride; various metal carbides such as silicon carbide and titanium carbide, various metal sulfides such as zinc sulfide, carbonates of various metals such as calcium carbonate and magnesium carbonate, sulfates of various metals such as calcium sulfate and magnesium sulfate, silicates of various metals such as calcium silicate and magnesium silicate, phosphates of various metals such as calcium phosphate, boric acid salts of various metals such as aluminum borate and magnesium borate, composites thereof, and plaster (each hydrate of calcium sulfate, and anhydride of calcium sulfate).

In addition, in each of the fluid compositions 31, 33, and 37, a solvent, a dispersion medium, and a binder are generally contained in addition to the particles M, C, and N of the three types of materials 21, 23, and 35 described above.

Examples of the solvent or dispersion medium include various types of water such as distilled water, pure water, and RO water, alcohols such as methanol, ethanol, 2-propanol, 1-butanol, 2-butanol, octanol, ethylene glycol, diethylene glycol, and glycerin, ethers (cellosolves) such as ethylene glycol monomethyl ether (methyl cellosolve), esters such as methyl acetate, ethyl acetate, butyl acetate, and ethyl formate, ketones such as acetone, methyl ethyl ketone, diethyl ketone, methyl isobutyl ketone, methyl isopropyl ketone, and cyclohexanone, aliphatic hydrocarbons such as pentane, hexane, and octane, cyclic hydrocarbons such as cyclohexane and methylcyclohexane, aromatic hydrocarbons having a long-chain alkyl group and a benzene ring such as benzene, toluene, xylene, hexylbenzene, heptylbenzene, octylbenzene, nonylbenzene, decylbenzene, undecylbenzene, dodecylbenzene, tridecylbenzene, and tetradecylbenzene, halogenated hydrocarbons such as methylene chloride, chloroform, carbon tetrachloride, and 1,2-dichloroethane, aromatic heterocyclic compounds containing any one of pyridine, pyrazine, furan, pyrrole, thiophene, and methylpyrrolidone, nitriles such as acetonitrile, propionitrile, and acrylonitrile, amides such as N,N-dimethylamide and N,N-dimethylacetamide, carboxylates, and other various oils.

The binder is not limited as long as the binder is soluble in the above solvent or dispersion medium. For example, an acrylic resin, an epoxy resin, a silicone resin, a cellulose resin, a synthetic resin, or the like can be used. In addition, thermoplastic resins such as polylactic acid (PLA), polyamide (PA), polyphenylene sulfide (PPS), or the like can be used.

In addition, the binder may not be in a soluble state and may be dispersed in the above solvent or dispersion medium in a state of minute particles of the resin such as the above acrylic resin.

(B) Solidification Step (Refer to FIG. 7)

The solidification step P2 is a step of applying energy E to the metal particles M of the first material 21 and the ceramic particles C of the ceramic material 23 in the layer D to solidify the particles. In Embodiment 5, the above three types of irradiation heads 61, 63, and 65 are used as means for applying the energy E, and it is configured to be able to perform the solidification step P2 every time the layer D is formed by laser beam E irradiated from the irradiation heads 61, 63, and 65.

Regarding the support material 25, since the support material 25 is unnecessary after the completion of the ceramic component 1A, the support material 25 will be removed later. Therefore, it is possible to be configured to reduce the output of the laser beam E irradiated from the third irradiation head 65 or to stop the irradiation of the laser beam E in the solidification step P2.

(C) Process Until Forming (Refer to FIG. 8)

Thereafter, the above layer formation step P1 and solidification step P2 are repeated a predetermined number of times in the lamination direction Z to form a desired three-dimensional shaped ceramic component 1A as illustrated in FIG. 8, and an unnecessary support material 25 is removed to form the ceramic component 1A as a product.

According to the three-dimensional manufacturing method of the ceramic component according to the present embodiment configured in this manner, it is possible to easily realize the gradient composition of the composite layer 11 provided at the bonding portion of the ceramic layer 9 while improving the heat resistance of the ceramic component 1A placed in the high temperature environment 5, and to improve the productivity of the ceramic component 1A.

### Another Embodiment

Although the ceramic component 1 and the three-dimensional manufacturing method of the ceramic component according to the present invention is basically based on having the configuration as described above, it is naturally possible to change or omit the partial configuration within the scope not deviating from the gist of the present invention.

For example, in a case of manufacturing the ceramic component 1B according to Embodiment 2, in the layer formation step P1 in the above-described three-dimensional manufacturing method of the ceramic component, the ceramic layers 9 can be formed on the plurality of layers 9A and 9B with different ceramic materials 23 and 27, and the fluid composition 33 of the ceramic materials 23 and 27 can be ejected from each ejection portion 53 such that the separate composite layer 15 forms the gradient composition between the respective layers of the plurality of layers 9A and 9B.

In addition, in a case of manufacturing the ceramic component 1C according to Embodiment 3, in the layer formation step P1 in the above-described three-dimensional manufacturing method of the ceramic component, the ceramic layers 9 can be formed on the plurality of layers 9A and 9C having different properties, and the fluid composition 33 of the ceramic materials 23 and 29 corresponding to each of the properties can be ejected from each ejection portion 53 such that the separate composite layer 17 forms the gradient composition between the respective layers of the plurality of layers 9A and 9C.

In addition, the number of the robot arms 43, 45, and 47, the number of the ejection heads 51, 53, and 55, and the number of the irradiation heads 61, 63, and 65 of the three-dimensional manufacturing apparatus 41 used for manufacturing the ceramic component 1 of the present invention can be appropriately increased or decreased according to the type of the fluid composition to be used.

In addition, the three-dimensional manufacturing apparatus 41 is not limited to an articulated industrial robot having the above-described structure, and various three-dimensional manufacturing apparatuses having different structures such as a slide table type robot provided with a table sliding in the width direction X, the depth direction Y, and the lamination direction Z, and an industrial robot with cylindrical coordinate system can be applied.

In addition, the above-described solidification step P2 may be performed every time each layer D is formed, and solidification may be performed by collectively placing the formed ceramic component 1 before solidification in a sintering furnace, for example, after all the layers D are formed.

1. A ceramic component placed in high temperature environment, the component comprising:
a first member that is formed of a first material; and
a ceramic layer that is bonded to a surface of the first member, which is a side exposed to the high temperature environment and that is formed of a ceramic material having a higher heat resistance than that of the first member,
wherein a bonding portion between the first member and the ceramic layer is formed of
a composite material having the first material and the ceramic material, and
a gradient composition in which an abundance ratio of the first material gradually decreases and an abundance ratio of the ceramic material gradually increases in a direction from the first member to the ceramic layer.

2. The ceramic component according to claim 1,
wherein the ceramic layer is formed of a plurality of layers,
the plurality of layers are formed of different ceramic materials, and
the bonding portions of the respective layers of the plurality of layers are configured to have the gradient composition.

3. The ceramic component according to claim 1,
wherein the ceramic layer is formed of a plurality of layers,
the plurality of layers have different properties, and
the bonding portions of the respective layers of the plurality of layers are configured to have the gradient composition.

4. The ceramic component according to claim 1,
wherein an entire surface of the first member is covered with the ceramic layer.

5. The ceramic component according to claim 1,
wherein a layer thickness of the ceramic layer is 200 μm or more.

6. The ceramic component according to claim 1,
wherein a thickness of the gradient composition portion is 200 μm or more.

7. The ceramic component according to claim 1,
wherein the first material is one or more materials selected from an SUS alloy, a titanium alloy, a nickel base alloy, and a cobalt base alloy, and
the ceramic material is one or more materials selected from alumina, zirconia, silicon nitride, aluminum nitride, silicon carbide, cordierite, mullite, steatite, calcia, magnesia, sialon, yttria stabilized zirconia, Dy₂O₃—ZrO₂, Y₂O₃—HfO₂, ZrB₂, and HfB₂.

8. A three-dimensional manufacturing method of a ceramic component placed in a high temperature environment and which includes a first member formed of a first material, and a ceramic layer bonded to a surface of the first member, which is a side exposed to the high temperature environment and formed of a ceramic material having a higher heat resistance than that of the first member, the method comprising:
a layer formation step of forming one layer by ejecting a first fluid composition containing particles of the first material from a first ejection portion to a portion corresponding to the first member, ejecting a second fluid composition containing particles of the ceramic material from a second ejection portion to a portion corresponding to the ceramic layer, and ejecting each of the fluid compositions so as to form a gradient composition in which an abundance ratio of the particles of the first material gradually decreases and an abundance ratio of the particles of the ceramic material gradually increases in a direction from the first member to the ceramic layer at a portion corresponding to a bonding portion between the first member and the ceramic layer; and
a solidification step of applying energy to each particle in the layer to solidify the particles,
wherein the ceramic component is formed by repeating the layer formation step and the solidification step in a lamination direction.

9. The three-dimensional manufacturing method of the ceramic component according to claim 8,
wherein in the layer formation step, the ceramic layer is formed on a plurality of layers with different ceramic materials, and
a fluid composition of the each of the ceramic materials is ejected from each ejection portion so as to form the gradient composition between the respective layers of the plurality of layers.

10. The three-dimensional manufacturing method of the ceramic component according to claim 8,
wherein in the layer formation step, the ceramic layer is formed on a plurality of layers with different properties, and
a fluid composition of the ceramic material corresponding to each property is ejected from each ejection portion so as to form the gradient composition between the respective layers of the plurality of layers.
